(19) United States
(12) Patent Application Publication
(10) Pub. No.: US 2020/0211223 A1
(43) Pub. Date: Jul. 2, 2020

(54) SYSTEM AND METHOD FOR PROVIDING SPATIAL INFORMATION OF AN OBJECT TO A DEVICE

(71) Applicant: SIGNIFY HOLDING B.V., EINDHOVEN (NL)

(72) Inventors: BARTEL MARINUS VAN DE SLUIS, EINDHOVEN (NL); DZMITRY VIKTOROVICH ALIAKSEYEU, EINDHOVEN (NL); MUSTAFA TOLGA EREN, EINDHOVEN (NL); DIRK VALENTINUS RENE ENGELEN, HEUSDEN-ZOLDER (BE)

(21) Appl. No.: 16/631,252

(22) PCT Filed: Jul. 10, 2018
(86) PCT No.: PCT/EP2018/068595

§ 371 Date: Jan. 15, 2020

(30) Foreign Application Priority Data
Jul. 19, 2017 (EP) 17182009.5

(51) Int. Cl. G06T 7/73; G01S 5/16; H04B 10/116

(52) U.S. Cl. CPC G06T 7/75; G06T 2207/30261; H04B 10/116; G01S 5/16

(57) ABSTRACT

A method (600) of providing spatial information of an object (110) to a device (100) is disclosed. The method (600) comprises: detecting (602), by the device (100), light (118) emitted by a light source (112) associated with the object (110), which light (118) comprises an embedded code representative of a two-dimensional or three-dimensional shape having a predefined position relative to the object (110), obtaining (604) a position of the object (110) relative to the device (100), and determining (606) a position of the shape relative to the device (100) based on the predefined position of the shape relative to the object (110) and on the position of the object (110) relative to the device (100).

### FIELD OF THE INVENTION

The invention relates to a method of providing spatial information of an object to a device. The invention further relates to a computer program product for executing the method. The invention further relates to a device for receiving spatial information of an object.

### BACKGROUND

With the emergence of augmented reality (AR), self-driving vehicles, robots and drones the need for spatial information about objects in the environment keeps increasing. Currently, AR systems and autonomous vehicles rely on sensor information, which is used to determine the spatial characteristics of objects in their proximity. Examples of technologies that are used to determine for example the size and distance of objects in the environment are LIDAR or Radar. Other technologies use cameras or 3D/depth cameras to determine the spatial characteristics of objects in the environment. A disadvantage of these existing technologies is that they rely on what is in their field of view, and that the spatial characteristics need to be estimated based thereon.

### SUMMARY OF THE INVENTION

It is an object of the present invention to provide additional spatial information for devices that require spatial information about objects in their environment.

The object is achieved by a method of providing spatial information of an object to a device, the method comprising:
detecting, by the device, light emitted by a light source associated with the object, which light comprises an embedded code representative of a two-dimensional or three-dimensional shape having a predefined position relative to the object,
obtaining a position of the object relative to the device, and
determining a position of the shape relative to the device based on the predefined position of the shape relative to the object and on the position of the object relative to the device.

The two-dimensional (2D) or three-dimensional (3D) shape may for example be representative of a two-dimensional area that is covered by the object or a three-dimensional model of the object or of a safety volume defined around the object. The device may detect the light comprising the embedded code representative of the shape, and retrieve the embedded code from the light, and retrieve the shape based on the embedded code. Shape information about the shape may be comprised in the embedded code, or the embedded code may comprise a link to the shape information. By obtaining the position of the object relative to the device, the device is able to determine the position of the shape because the shape has a predefined position relative to the object. This is beneficial, because next to knowing the position of the object, the device has access to additional information about the spatial characteristics of the object: its shape.

The shape may be representative of a three-dimensional model of the object. The (virtual) 3D model may be a mathematical representation of the surface of the object, for example a polygonal model, a curve model, or a collection of points in 3D space. The (virtual) 3D model substantially matches the physical 3D model of the object. In other words, the 3D model is indicative of the space that is taken up by the object. This is beneficial, because it enables the device to determine exactly which 3D space is taken up by the object.

The shape may be representative of a two-dimensional area covered by the object. The (virtual) 2D model may be a mathematical representation of a 2D surface of the object, for example a polygonal model, a curve model, or a collection of points in 2D space. The two-dimensional area may be an area in the horizontal plane, which area represents the space taken up by the object in the horizontal plane. For some purposes, the two-dimensional area information of the object is sufficient (compared to a more complex 3D model). This enables the device to determine exactly which area in the space is taken up by the object.

The shape may be representative of a bounding volume of the object. The 3D bounding volume may for example be a shape (e.g. a box, sphere, capsule, cylinder, etc.) having a 3D shape that (virtually) encapsulates the object. The bounding volume may be a mathematical representation, for example a polygonal model, a curve model, or a collection of points in 3D space. A benefit of a bounding volume is that it is less detailed than a 3D model, thereby significantly reducing the required computing power for computing the space that is taken up by the object.

The shape may be representative of a bounding area of the object. With the term “bounding area” a 2D variant of a 3D bounding volume is meant. In other words, the bounding area is an area in a 2D plane, for example the horizontal plane, which encapsulates the 2D space taken up by the object. A benefit of a bounding area is that it is less detailed than a 2D area covered by the object, thereby significantly reducing the required computing power for computing the space that is taken up by the object.

Obtaining the position of the object relative to the device can be achieved in different ways.

The step of obtaining the position of the object relative to the first may comprise: receiving a first set of coordinates representative of a position of the device, receiving a second set of coordinates representative of a position of the object, and determining the position of the object relative to the device based on the first and second sets of coordinates. This is beneficial because by comparing the first and second sets of coordinates the position of the object relative to the device can be calculated without being dependent on any distance/image sensor readings.

The step of obtaining the position of the object relative to the device may comprise: emitting a sense signal by an emitter of the device, receiving a reflection of the sense signal reflected off the object, and determining the position of the object relative to the device based on the reflection of the sense signal. The sense signal, for example a light signal, a radio signal, an (ultra)sound signal, etc. is emitted an emitter of the device. The device may comprise multiple emitters (and receivers for receiving sense signals reflected off the object) to determine the distance/position of objects surrounding the device. This enables determining a precise distance and position of objects relative to the device.

The step of obtaining the position of the object relative to the device may comprise: capturing an image of the object, analyzing the image, and determining the position of the object relative to the device based on the analyzed image. The device may comprise one or more image capturing devices (cameras, 3D cameras, etc.) for capturing one or more images of the environment. The one or more images may be analyzed to identify the object, and to determine its position relative to the device.

The light source may have a predetermined position relative to the object, and the step of obtaining the position of the object relative to the device may comprise: determining a position of the light source relative to the device, and determining the position of the object relative to the device based on the predetermined position of the light source relative to the object. The position of the light source relative to the device may be determined based on a signal received from a light sensor. The light intensity or the signal to noise ratio of the code embedded in the light for example may be indicative of a distance of the light source. Alternatively, the position of the light source relative to the device may be determined by analyzing images captured of the object and the first light source. The embedded code may be further representative of the predetermined position of the light source relative to the object. This enables the device to determine the position of the object relative to the light source of which the position has been determined.

The device may comprise an image capture device and an image rendering device, and the method may further comprise: capturing, by the image capture device, an image of the object, determining a position of the object in the image, determining a position of the shape relative to the object in the image, determining a virtual position for a virtual object relative to the shape in the image, and rendering the virtual object as an overlay on the physical environment at the virtual position on the image rendering device. It is known to position virtual content as an overlay on top of the physical environment. This is currently done by analyzing images captured of the physical environment, which requires a lot of computing power. Thus, it is beneficial if the (3D) shape of the object is known to the device, because this provides information about the (3D) space taken up by the object. This provides a simplified and more accurate way of determining where to position the virtual object and therefore improves augmenting the physical environment with virtual objects (augmented reality). In embodiments, the virtual object may be a virtual environment, and the virtual environment may be rendered around the object. This therefore also improves augmenting the virtual environment with (physical) objects (augmented virtuality).

The device may be a vehicle. Additionally, the object may be a road user (e.g. a vehicle, a pedestrian, a cyclist, etc. equipped with the light source) or road infrastructure (e.g. a lamp post, a building, a plant/tree, etc. equipped with the light source). For instance, the device and the object may be vehicles. The second vehicle may comprise a light source that emits a code representative of a 3D model of the second vehicle. The first vehicle may determine its location relative to the second vehicle (e.g. based on GPS coordinates, based on sensor readings from a LIDAR/radar system, etc.), detect the light emitted by the light source of the second vehicle, retrieve the embedded code from the light and use the embedded code to retrieve the shape. This is beneficial, because next to knowing the position of the second vehicle, the first vehicle has access to additional information about the spatial characteristics of the second vehicle, for example its 3D shape. This information may, for example, be used by an autonomous driving vehicle to determine when it is safe to switch lanes, assess the time needed for overtaking another vehicle, where and how to park the vehicle, etc.

The shape's size, form and/or position relative to the object may be based on a movement speed of the object, a user input indicative of a selection of the size and/or the form, a user profile, a current state of the object, and/or weather, road and/or visibility conditions. A benefit of a dynamically adjustable shape may be beneficial, for example for autonomous driving vehicles. The size of the shape may for example increase when the speed of a second vehicle increases, thereby informing other vehicles that detect a code embedded in the light emitted by a light source associated with the second vehicle that they should keep more distance.

The embedded code may be further representative of a surface characteristic of a surface of the object. The surface characteristic provides information about at least a part of the surface of the object. Examples of surface characteristics include but are not limited to color, transparency, reflectivity and the type of material. Surface characteristic information may be used when analyzing images of the object in order to improve the image analysis and object recognition process. Surface characteristic information may also be used to determine how to render virtual objects as an overlay at or nearby the (physical) object.

The method may further comprise the steps of:
capturing an image of the object,
identifying one or more features of the object in the image,
determining the two-dimensional or three-dimensional shape of the object based on the one or more features,
detecting light emitted by a proximate light source, which proximate light source is in proximity of the object, which light comprises an embedded code comprising a light source identifier of the proximate light source,
identifying the proximate light source based on the embedded code, and
storing an association between the proximate light source and the two-dimensional or three-dimensional shape of the object in a memory.

The features of the object (e.g. edges of the object, illumination/shadow characteristics of the object, differences in color of the object, 3D depth information, etc.) may be retrieved by analyzing the image of the object. The image may be a 2D image, or an image captured by a 3D camera. Based on these features, an estimation of the two-dimensional or three-dimensional shape can be made. In embodiments, multiple images captured from different directions of the object may be stitched together and used to determine the two-dimensional or three-dimensional shape of the object. The light source that is proximate to the object may be identified based on the embedded code comprised in the light emitted by the light source. This enables creation of the associations between the object (and its shape) and the light source.

According to a second aspect of the present invention, the object is achieved by a computer program product for a computing device, the computer program product comprising computer program code to perform any of the above-mentioned methods when the computer program product is run on a processing unit of the computing device.

According to a third aspect of the present invention, the object is achieved by a device for receiving spatial information of an object, the device comprising:
a light detector configured to detect light emitted by a light source associated with the object, which light comprises an embedded code representative of a two-dimensional or three-dimensional shape having a predefined position relative to the object, and
a processor configured to obtain a position of the object relative to the device, and to determine a position of the shape relative to the device based on the predefined position of the shape relative to the object and on the position of the object relative to the device.

According to a fourth aspect of the present invention, the object is achieved by an object for providing its spatial information to the device, the object comprising:
a light source configured to emit light, which light comprises an embedded code representative of a two-dimensional or three-dimensional shape having a predefined position relative to the object.

The device and the object may be part of a system. It should be understood that the device, the object and the system may have similar and/or identical embodiments and advantages as the claimed method.

According to a further aspect of the present invention, the object is achieved by a method of associating a two-dimensional or three-dimensional shape of an object with a light source, the method comprising:
capturing an image of the object,
identifying one or more features of the object in the image,
determining the two-dimensional or three-dimensional shape of the object based on the one or more features,
detecting light emitted by a proximate light source, which proximate light source is in proximity of the object, which light comprises an embedded code comprising a light source identifier of the proximate light source,
identifying the proximate light source based on the embedded code, and
storing an association between the proximate light source and the two-dimensional or three-dimensional shape of the object in a memory.

The shape may be representative of a three-dimensional model of the object, a two-dimensional area covered by the object, a bounding volume of the object, or a bounding area of the object. The features of the object (e.g. edges of the object, illumination/shadow characteristics of the object, differences in color of the object, 3D depth information, etc.) may be retrieved by analyzing the image of the object. The image may be a 2D image, or an image captured by a 3D camera. Based on these features, an estimation of the two-dimensional or three-dimensional shape can be made. In embodiments, multiple images captured from different directions of the object may be used to determine the two-dimensional or three-dimensional shape of the object. The light source that is proximate to the object may be identified based on the embedded code comprised in the light emitted by the light source. This enables creation of the associations between the object (and its shape) and the light source.

### BRIEF DESCRIPTION OF THE DRAWINGS

The above, as well as additional objects, features and advantages of the disclosed objects and devices and methods will be better understood through the following illustrative and non-limiting detailed description of embodiments of devices and methods, with reference to the appended drawings, in which:

FIG. 1 shows schematically an embodiment of a system comprising a device for receiving spatial information of an object;

FIG. 2 shows schematically examples of a 3D model, a 2D area, a bounding volume and a bounding area of a vehicle;

FIG. 3 shows schematically an example of providing spatial information of road users to a vehicle;

FIGS. 4a and 4b show schematically examples of a mobile device for associating a two-dimensional or three-dimensional shape of an object with a light source;

FIG. 5 shows schematically an example of a device for receiving spatial information of an object, wherein the object is a room;

FIG. 6 shows schematically a method of providing spatial information of an object to a device; and

FIG. 7 shows schematically a method of associating a two-dimensional or three-dimensional shape of an object with a light source.

All the figures are schematic, not necessarily to scale, and generally only show parts which are necessary in order to elucidate the invention, wherein other parts may be omitted or merely suggested.

### DETAILED DESCRIPTION OF EMBODIMENTS

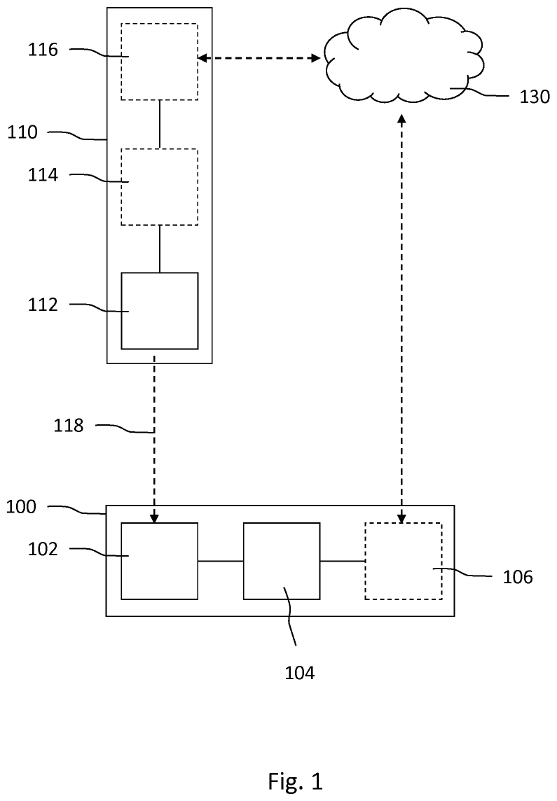

FIG. 1 illustrates a system comprising a device 100 for receiving spatial information of an object 110. The device 100 comprises a light detector 102 configured to detect light 118 emitted by a light source 112 associated with the object 110, which light 118 comprises an embedded code representative of a two-dimensional or three-dimensional shape having a predefined position relative to the object 110. The device 100 further comprises a processor 104 configured to obtain a position of the object 110 relative to the device 100, and to determine a position of the shape relative to the device 100 based on the predefined position of the shape relative to the object 110 and based on the position of the object 110 relative to the device 100.

The object 110 is associated with the light source 112, such as an LED/OLED light source, configured to emit light 118 which comprises the embedded code. The light source 112 may be attached to/co-located with the object 110. The light source 112 may illuminate the object 110. The code may be created by any known principle of embedding a code in light, for example by controlling a time-varying, modulated current to the light source 112 to produce variations in the light output, by modulating the amplitude and/or the duty-cycle of the light pulses, etc.

The object 110 may further comprise a processor 114 for controlling the light source 112 such that it emits light 118 comprising the embedded code. The processor 114 may be co-located with and coupled to the light source 112.

The object 110 may be an object with an integrated light source 112 (e.g. a vehicle, a lamp post, an electronic device with an indicator LED, etc.). Alternatively, the light source 112 (and, optionally, the processor 114 and/or the communication unit 116) may be attachable to the object 110 (e.g. a human being, an electronic device, a vehicle, building/road infrastructure, a robot, etc.) via any known attachment means. Alternatively, the light source 112 may illuminate the object 110 (e.g. a lamp illuminating a table). Alternatively, the light source 112 may be located inside the object 110 (e.g. a lamp located inside an environment such as (a part of) a room).

The light detector 102 of the device 100 is configured to detect the light 118 and the code embedded therein. The processor 104 of the device 100 may be further configured to retrieve the embedded code from the light 118 detected by the light detector 102. The processor 104 may be further configured to retrieve the shape of the object 110 based on the retrieved code. In embodiments, shape information about the shape may be comprised in the code, and the processor 104 may be configured to retrieve the shape information from the code in order to retrieve the shape of the object 110. In embodiments, the embedded code may comprise a link to the information about the shape of the object 110, and the information about the shape of the object 110 may for example be retrieved from a software application running on the device 100 or from a remote server 130.

The device 100 may further comprise a communication unit 106 for communicating with a remote server 130, for example to retrieve the shape information from a memory of the remote server. The device 100 may communicate with the remote server via a network, via internet, etc.

The object 110 may further comprise a processor 114, or the processor 114 may be comprised in a further device, such as a remote server 130. The object 110 may further comprise a communication unit 116. The processor 114 of the object 110 may, for example, be configured to control the light source 112 of the object 110, such that the light source 112 emits light 118 comprising the embedded code. The processor 114 may be configured to retrieve information about the shape of the object 110 and control the light source 112 based thereon, for example by embedding shape information in the light 118 emitted by the light source 112, or by embedding an identifier of the object 110 or a link to the shape information in the light 118 such that the processor 104 of the device 100 can identify the object 110 and retrieve the shape information based thereon. The object 110 may further comprise a communication unit 116 for communicating with, for example, a remote server 130 to provide the remote server with information about the object 110. This information may, for example, comprise identification information, shape information or any other information of the object 110 such as properties of the object 110.

The processor 104 (e.g. circuitry, a microchip, a microprocessor) of the device 100 is configured to obtain a position of the object 110 relative to the device 100. Obtaining the position of the object 110 relative to the device 100 can be achieved in different ways.

The processor 104 may, for example, be configured to receive a first set of coordinates representative of a position of the device 100 and a second set of coordinates representative of a position of the object 110. The processor 104 may be further configured to determine the position of the object 110 relative to the device 100 based on the first and second sets of coordinates. The sets of coordinates may, for example, be received from an indoor positioning, such as a radio frequency (RF) based beacon system or a visible light communication (VLC) communication system, or an outdoor (global) positioning system. This enables the processor 104 to determine the position of the object 110 relative to the device 100.

The position of the object 110 may be communicated to the device 100 via the light 118 emitted by the light source 112. The embedded code comprised in the light 118 may further comprise information about the position of the object 110.

Additionally or alternatively, the device 100 may comprise an emitter configured to emit a sense signal. The device 100 may further comprise a receiver configured to receive a reflection of the sense signal reflected off the object 110. The processor 104 may be further configured to control the emitter and the receiver, and to determine the position of the object 110 relative to the device 100 based on the reflection of the sense signal. The device 100 may for example use LIDAR. The emitter may emit pulsed laser light and measure reflected light pulses with a light sensor. Differences in laser light return times and wavelengths can then be used to make digital 3D-representations of the object 110. Additionally or alternatively, the device 100 may use radar. The emitter may emit radio waves, and the receiver may receive reflected radar waves of the object 110 to determine the distance of the object 110.

Additionally or alternatively, the device 100 may comprise an image capturing device configured to capture one or more images of the object 110. The image capture device may, for example, be a camera, a 3D camera, a depth camera, etc. The processor 104 may be configured to analyze the one or more images and determine the position of the object 110 relative to the device 100 based on the analyzed one or more images.

Additionally or alternatively, the light source 112 associated with the object 110 may have a predetermined position relative to the object 110 (e.g. at the center of the object, in a specific corner of the object, etc.). The processor 104 may be configured to determine a position of the light source 112 relative to the device 100 and determine the position of the object relative to the device 100 based on the predetermined position of the light source 112 relative to the object 110. The processor 104 may determine the position of the light source 112 relative to the device 100 based on a signal received from a light sensor (e.g. the light detector 102). The light intensity or the signal to noise ratio of the code embedded in the light 118 may be indicative of a distance of the light source. This enables the processor 104 to determine a distance between the device 100 and the light source 112, and, since the light source 112 has a predetermined position relative to the object 110, therewith the position of the object 110 relative to the device 100. Alternatively, the position of the light source 112 relative to the device 100 may be determined by analyzing images captured of the first light source 100. The embedded code may be further representative of the predetermined position of the light source 112 relative to the object 110. The processor 104 of the device 100 may determine the position of the object 110 relative to the light source 112 based on the embedded code.

The shape may be any 2D or 3D shape. The shape may be a shape specified by a user, or scanned by a 3D scanner or based on multiple images of the object 110 captured by one or more (3D) cameras. Alternatively, the shape may be predefined, based on, for example, a CAD (computer-aided design) model of the object 110. In some embodiments, the shape may encapsulate at least a part of the object 110. In some embodiments, the shape may encapsulate the object 110, either in a 2D plane or in a 3D space. In embodiments, the shape may be positioned distant from the object 110. This may be beneficial if it is desired to ‘fool’ a device 100 about the position of the object 110. An ambulance driving at high speed may for example comprise a light source that emits light comprising a code indicative of a shape that is positioned in front of the ambulance in order to inform (autonomous) vehicles that they should stay clear of the space in front of the ambulance.

The shape may have a first point of origin (e.g. a center point of the shape) and the object may have a second point of origin (e.g. a center point of the object). The position of second point of origin (and therewith the position of the object 110) may be communicated to the device 100. The position of second point of origin may, for example, correspond to a set of coordinates of the position of the object 110, or it may correspond to the position of the light source 112 at the object. The position of first point of origin (i.e. the point of origin of the shape) may correspond to the position of the second point of origin. Alternatively, the position of first point of origin (i.e. the point of origin of the shape) may be offset relative to the position of the second point of origin. The embedded code may be further representative of the information about the first point of origin of the shape relative to the second point of origin of the object 110.

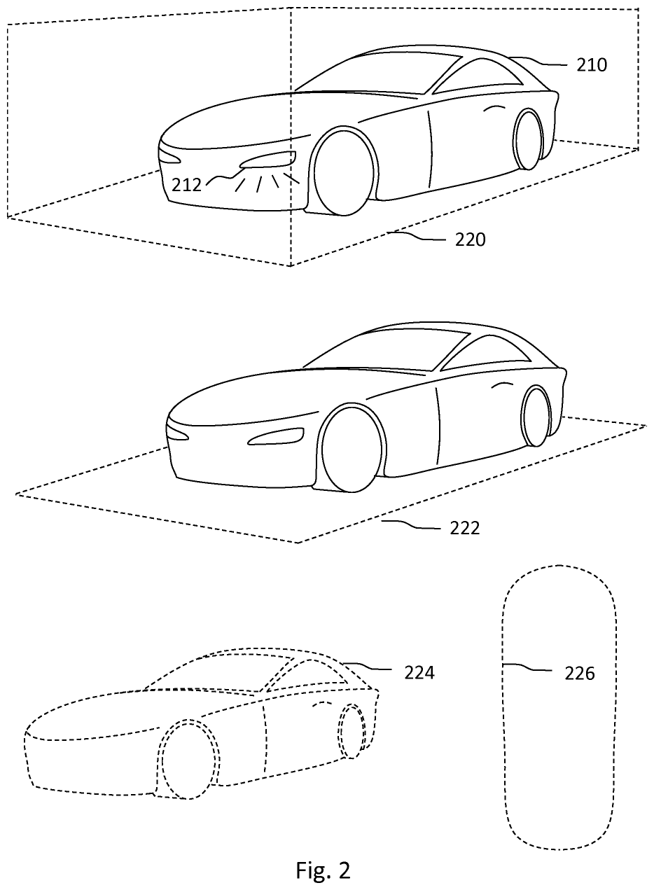

FIG. 2 illustrates multiple examples of shapes of an object 210. The object 210 comprises a light source 212 configured to emit light comprising the embedded code representative of the shape.

The shape 220 may be representative of a bounding volume 220 of the object 210. The 3D bounding volume 220 may for example be a shape (e.g. a box, sphere, capsule, cylinder, etc.) having a 3D shape/form that (virtually) encapsulates the object 220. FIG. 2 illustrates an example of a bounding volume 220 of a vehicle 210.

Alternatively, the shape 222 may be representative of a bounding area 222 of the object 210. With the term “bounding area” a 2D variant of a 3D bounding volume is meant. In other words, the bounding area 222 is an area in a 2D plane, for example the horizontal or vertical plane, which encapsulates the 2D space taken up by the object 210. FIG. 2 illustrates an example of a bounding area 222 of a vehicle 210 in the horizontal plane.

The shape 224 may be representative of a three-dimensional model 224 of the object 210. The (virtual) 3D model 224 may be a mathematical representation of the surface of the object 210, for example a polygonal model, a curve model or a collection of points in 3D space. The (virtual) 3D model 224 substantially matches the physical 3D model of the object 210. In other words, the (virtual) 3D model 224 is indicative of the space that is taken up by the object in the 3D space. FIG. 2 illustrates an example of a 3D model 224 of a vehicle 210.

The shape 226 may be representative of a two-dimensional area 226 covered by the object. The two-dimensional area 226 may for example be an area in the horizontal plane, which area represents the space taken up by the object in the horizontal plane. FIG. 2 illustrates an example of a two-dimensional area 226 of a vehicle 210.

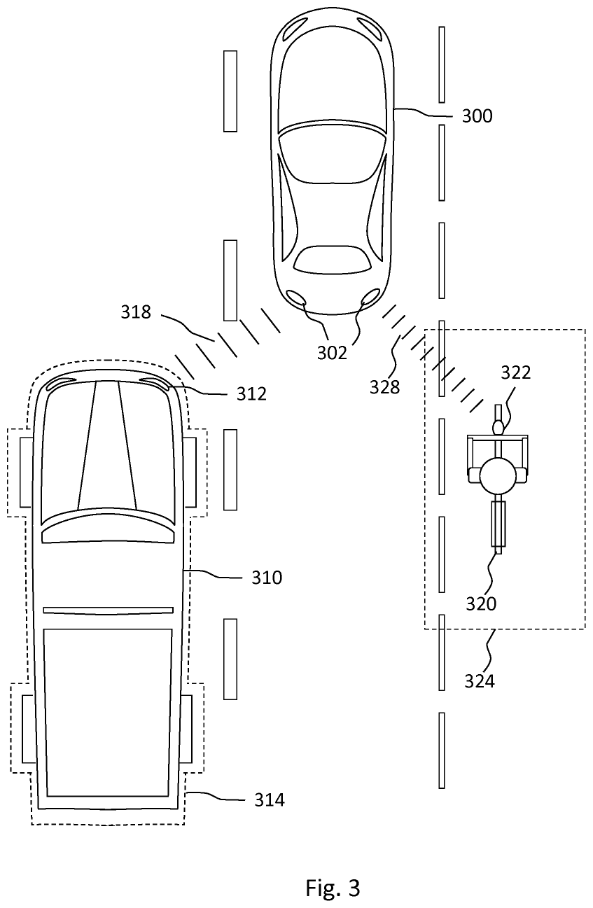

The processor 104 is further configured to determine a position of the shape relative to the device 100 based on the predefined position of the shape relative to the object 110 and based on the position of the object 110 relative to the device 100. This is further illustrated in FIG. 3. In FIG. 3, a device 300 (a first vehicle) may obtain the position of an object (a second vehicle) 310. Now, the position of the object 310 is known to the device 300. A processor (not shown) of the device 300 may retrieve an embedded code from light 318 emitted by a light source 312 of the object 310, which code is representative of a shape 314 (the shape 314 may for instance be a 3D model of the object 310). Since the position of the object 310 relative to the device 300 is known, and the shape 314 of the object 310 has a predefined position relative to that object 310, the processor of the device 300 is able to determine the position of the shape 314 relative to the device 300 (which in this example is the same position as the object 310). In another example in FIG. 3, the processor of the device 300 may retrieve an embedded code from light 328 emitted by a light source 322 of another object 320, which code is representative of a shape 324 (the shape 324 may for instance be a 2D area surrounding the object 320). Since the position of the object 320 relative to the device 300 is known, and the shape 324 of the object 320 has a predefined position relative to that object 320, the processor of the device 300 is able to determine the position of the shape 324 relative to the device 300. In this example, the center of the shape 324 and the center of the object 320 have the same positions.

The processor (not shown in FIG. 3) of the vehicle 300 may be further configured for communicating the position of the shape to an automated driving system of the vehicle 300. The automated driving system may be configured to control the vehicle 300 such that it stays clear from the position of the shape.

In the examples of FIG. 2 and FIG. 3 the device 100 and the object 110 are vehicles/road users, but the first and objects may also be other types of objects or devices. The device 100 may, for example, be a device, such as a smartphone, tablet pc, smartwatch, smartglasses, etc., comprising an image rendering device. The processor 104 may be configured to render virtual objects (e.g. virtual characters, a virtual environment, documents, a virtual interface, etc.) on the image rendering device. The device 100 may further comprise an image capture device (e.g. a (depth) camera). The image rendering device may be a display, and the processor may render images captured by the image capturing device on the display and render virtual objects as an overlay on top of these images. Alternatively, the image rendering device may be a projector configured to project virtual objects, for example on smartglasses, or directly on the retina of the user, as an overlay on a physical environment wherein the device 100 is located.

The image capture device may be configured to capture an image of the object 110. The processor 104 may be configured to determine a position of the object in the image and a position of a retrieved shape (for example a 3D model of the object 110) relative to the object 110 in the image. Based on this position of the shape, the processor 104 may further determine a virtual position for a virtual object relative to the shape in the image, and render the virtual object as an overlay on the physical environment at the virtual position on the image rendering device. As a result, the processor 104 positions the virtual object/virtual content on the image rendering device at a position relative to the shape of the object 110 and therewith relative to the object 110. The virtual object may, for example, be an overlay on top of the physical object to change the appearance of the object 110, for example its color, which would enable a user to see how the object 110 would look in that color. Alternatively, the virtual object may, for example, be object information of the object 110 that is rendered next to/as an overlay on top of the object 110. Alternatively, the virtual object may, for example, be a virtual character that is positioned on or moves relative to the object 110.

The shape's size, form and/or its position relative to the object 110 may be determined dynamically. The processor 114 of the object 110 may be configured to change the shape based on/as a function of environmental parameters and/or parameters of the object 110. Alternatively, the shape may be changed by a controller of a remote server 130. The object 110 may further comprise sensors for detecting the environmental parameters and/or the parameters of the object 110. Alternatively, the environmental parameters and/or the parameters of the object 110 may be determined by external sensors and be communicated to the processor 114 and/or the remote server.

The shape may, for example, be dependent on a movement speed of the object 110. When the object 110 is a vehicle or another road user that moves with a certain speed, it may be beneficial to increase the size of the shape such that other vehicles can anticipate on this by staying clear from the position covered by the (new) shape. If an object 110, such as a vehicle, is accelerating, the shape may be positioned ahead of the vehicle such that other vehicles can anticipate on this by staying clear from the position covered by the (new) shape.

Additionally or alternatively, the shape's size, the form and/or the position relative to the object 110 may be determined by a user. A user may provide a user input to set the size, the form and/or the position relative to the object 110.

Additionally or alternatively, the shape's size, form and/or position relative to the object 110 may be determined based on a user profile. The user profile may for example comprise information about the age, eye sight, driving experience level, etc. of a user operating the object 110, e.g. a vehicle.

Additionally or alternatively, the shape's size, the form and/or the position relative to the object 110 may be determined based on a current state of the object 110. Each state/setting of an object 110 may be associated with a specific shape. The object 110, for example an autonomous vehicle, may have an autonomous setting and a manual setting, and the shape's size may be set dependent thereon. In another example, a cleaning robot's shape may be dependent on an area that needs to be cleaned, which area may decrease over time as the cleaning robot cleans the space.

Additionally or alternatively, the shape's size, the form and/or the position relative to the object 110 may be dependent on weather conditions (e.g. snow/rain/sunshine), road conditions (e.g. slippery/dry, broken/smooth) and/or visibility conditions (e.g. foggy/clear, day/night). The object 110 may comprise sensors to detect these conditions, or the object 110 may obtain these conditions from a further device, such as a remote server 130. When the object 110 is a vehicle or another road user that moves with a certain speed, it may be beneficial to increase the size of the shape such that other vehicles can anticipate on this by staying clear from the position covered by the (new) shape.

The processor 114 of the object 110 may be further configured to control the light source such that the code is further representative of a surface characteristic of the object. Examples of surface characteristics include but are not limited to color, transparency, reflectivity and the type of material of the surface of the object 110. Surface characteristic information may be used by the processor 104 of the device 100 when analyzing images of the object 110 in order to improve image analysis and object recognition processes. Surface characteristic information may also be used to determine how to render virtual objects as an overlay on top of the physical environment at or nearby the (physical) object 110.

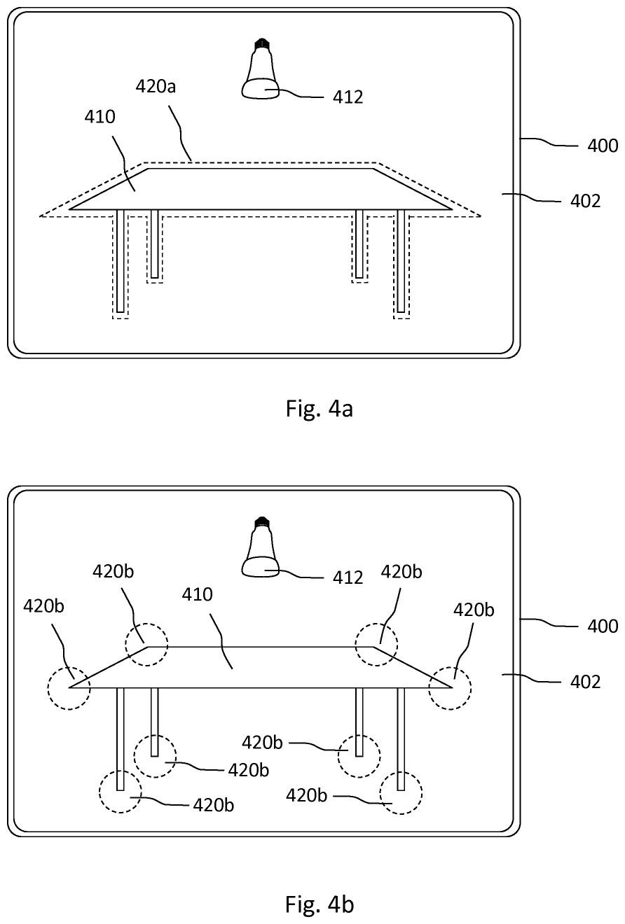

FIGS. 4a and 4b show schematically examples of a device 400 for associating a two-dimensional or three-dimensional shape of an object 410 with a light source 412. The device 400 may comprise a display 402 for rendering images captured by an image capturing device, e.g. a (3D) camera, of the device 400. The device 400 may be configured to capture one or more images of an object 410. The device 400 may further comprise a processor (not shown) configured to analyze the one or more images of the object 410, and to retrieve/identify one or more object features of the object 410 in the one or more images, and determine the two-dimensional or three-dimensional shape of the object 410 based on the one or more features. The features may, for example, be edges of the object (e.g. the edges of the table 410 in FIG. 4a) and may be detected as points/lines/surfaces/volumes in the 3D space. Other features that may be used to determine the shape of the object 410 are shadows, highlights, differences in contrast, etc.

The features may be further used to identify the object 410 (in this example a table), and, optionally, to retrieve the two-dimensional or three-dimensional shape of the object 410 from a memory (e.g. a database storing a plurality of tables, each associated with a respective 3D model) based on the identification of the object. The retrieved two-dimensional or three-dimensional shape may be mapped onto the object in the captured image, in order to determine the orientation/position of the object, and therewith its shape, in the space.

As illustrated in FIG. 4a, the detected shape may, for example, be an exact shape 420a of the object 410, or, as illustrated in FIG. 4b, (only) specific elements of the object 410 may be detected, for example only feature points 420b (e.g. edge/corner points) of the object 410.

The device 400 may further comprise a light detector (not shown) (e.g. a camera or a photodiode) configured to detect light emitted by a proximate light source 412, which proximate light source 412 is located in proximity of the object 410. The light emitted by the proximate light source 412 may comprise an embedded code representative of a light source identifier of the proximate light source 412. The processor may be further configured to retrieve the light source identifier from the embedded code, and to identify the proximate light source 412 by based on the light source identifier. This enables the processor to create an association between the shape 420a, 420b of the object 410 and the light source 412. The processor may be further configured to store the association in a memory. The memory may be located in the device 400, or the memory may be located remotely, for example in an external server, and the processor may be configured for communicating the association to the remote memory.

The processor may be configured to detect light emitted by a proximate light source, which proximate light source is in proximity of the object. The processor may be configured to select the proximate light source from a plurality of light sources by analyzing the image captured by an image capturing device. The processor may be configured to select the proximate light source based on the distance(s) of light source(s) between the object and the light source(s). Alternatively, the processor may be configured to select the proximate light source based on which light source illuminates the object. The processor may be configured to detect which light (and therewith which light source) illuminates the object. Alternatively, the processor may be configured to select a light source comprised in the object (e.g. a lamp in a room) or attached to the object (e.g. a headlight of a vehicle) as the proximate light source.

Storing the association in the memory, enables an (other) device 100 to retrieve the shape of the object 110 when the light emitted by the light source 112, when the light 118 comprises an embedded code representative of a two-dimensional or three-dimensional shape having a predefined position relative to the object 110, is detected by the device 100. The processor 104 of the device 100 may use the light source 112 as an anchor point when the position of the shape of the object 110 is being determined relative to the device 100.

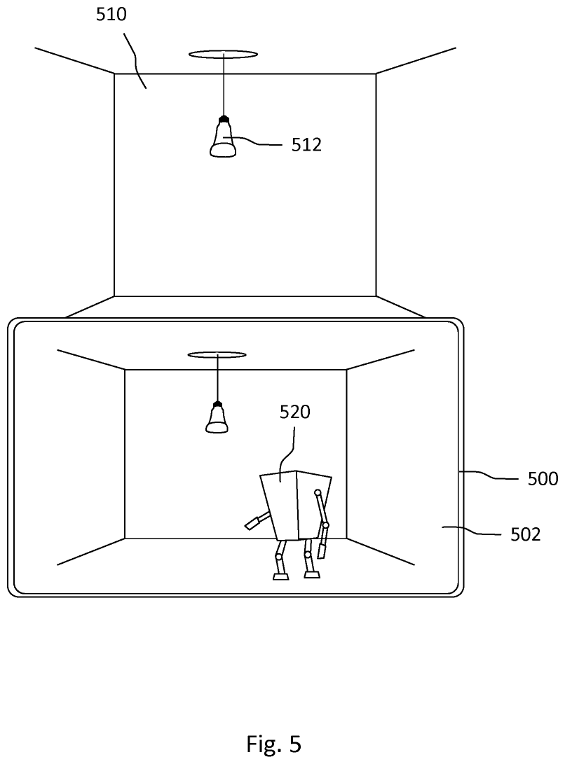

The object 110 may be (part of) an environment (such as indoor/outdoor infrastructure). The object 110 may be a room, a building, building infrastructure, road infrastructure, a garden, etc. This enables the device 100 to retrieve the shape (e.g. a 3D building model or depth map) from light 118 emitted by a light source 112 that is associated with that environment. The light source 112 may be located inside the environment. FIG. 5 shows schematically an example of a device 500 for receiving spatial information of an object 510, wherein the object 510 is a room 510. The device 500 may further comprise a light detector (not shown) such as a camera configured to detect light emitted by a light source 512 associated with the environment 510, which light comprises an embedded code representative of a two-dimensional or three-dimensional shape having a predefined position relative to the room 510. The device 500 may further comprise a processor configured to obtain a position of the environment 510 relative to the device 500, and to determine a position of the shape of the environment 510 relative to the device 500 based on the predefined position of the shape relative to the environment 510 and based on the position of the object 110 relative to the device 100. This enables the processor to determine where the device 500 is located in the environment 510. This may be beneficial for, for example, (indoor) positioning or AR purposes. The device 500 may be configured to render virtual objects on a display 502 of the device 500. The shape information of the environment 510 may be used to determine where to render a virtual object, such as a virtual character 520, virtual furniture, virtual documents or a virtual interface, as an overlay on top of the physical environment.

The system may comprise multiple light sources, and each light source may be installed in an environment, and each light source may be associated with a different part of the environment. A first light source may be associated with a first part of the environment and the first light source may emit light comprising shape information of the first part of the environment (a first object). A second light source may be associated with a second part of the environment and the second light source may emit light comprising shape information of the second part of the environment (a second object). Thus, when a user enters the first part of the environment with a device 100, the device 100 may detect the light emitted by the first light source, and the processor 104 of the device 100 may retrieve the shape information of the first part of the environment from the light of the first light source. When the user enters the second part of the environment with the device 100, the device 100 may detect the light emitted by the second light source, whereupon the processor 104 of the device 100 may retrieve the shape information of the second part of the environment from the light of the second light source. This is beneficial, for example for AR purposes, because the processor 104 will only retrieve relevant shape information of the environment that is in the field of view of the device 100. This may be relevant when the device 100 is configured to render virtual objects at specific physical locations as an overlay on top of the physical environment, wherein the shape information of the object (such as a 3D model of the (part of the) environment) is used as an anchor for the virtual objects. Selectively retrieving/downloading parts of the environment may reduce the buffer size and the computational power required for the processor for mapping the shape (e.g. the 3D model) of the object (e.g. the environment) onto the physical object.

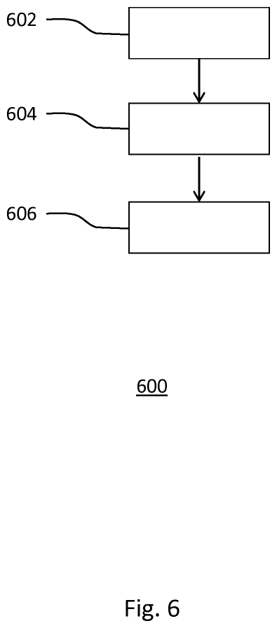

FIG. 6 shows schematically a method 600 of providing spatial information of an object 110 to a device 100. The method 600 comprises the steps of:
detecting 602, by the device 100, light 118 emitted by a light source 112 of the object 110, which light 118 comprises an embedded code representative of a two-dimensional or three-dimensional shape having a predefined position relative to the object 110,
obtaining 604 a position of the object 110 relative to the device 100, and
determining 606 a position of the shape relative to the device 100 based on the predefined position of the shape relative to the object 110 and on the position of the object 110 relative to the device 100.

The method 600 may be executed by computer program code of a computer program product when the computer program product is run on a processing unit of a computing device, such as the processor 104 of the device 100.

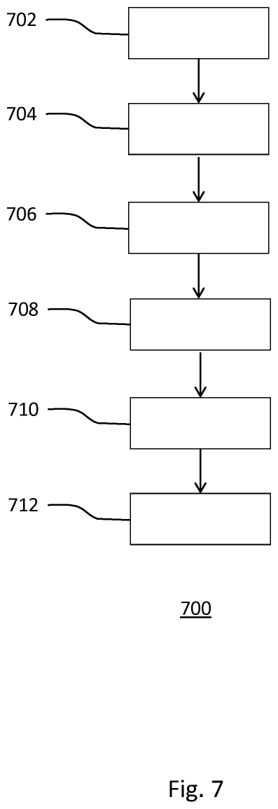

FIG. 7 shows schematically a method 700 of associating a two-dimensional or three-dimensional shape of an object with a light source. This method 700 may be additional to or alternative to the steps of the method 600. The method 700 comprises:
capturing 702 an image of the object 110,
identifying 704 one or more features of the object 110 in the image,
determining 706 the two-dimensional or three-dimensional shape of the object 110 based on the one or more features,
detecting 708 light emitted by a proximate light source, which proximate light source is in proximity of the object 110, which light comprises an embedded code comprising a light source identifier of the proximate light source,
identifying 710 the proximate light source based on the embedded code, and
storing 712 an association between the proximate light source and the two-dimensional or three-dimensional shape of the object 110 in a memory.

The method 700 may be executed by computer program code of a computer program product when the computer program product is run on a processing unit of a computing device, such as the processor 104 of the device 100.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A method of providing spatial information of an object to a device, the method comprising:
detecting, by the device, light emitted by a light source associated with the object, which light comprises an embedded code representative of a two-dimensional or three-dimensional shape having a predefined position relative to the object,
obtaining a position of the object relative to the device, and
determining a position of the shape relative to the device based on the predefined position of the shape relative to the object and on the position of the object relative to the device,
wherein the light source has a predetermined position relative to the object, and
wherein the step of obtaining the position of the object relative to the device comprises:
determining a position of the light source relative to the device, and
determining the position of the object relative to the device based on the predetermined position of the light source relative to the object.

2. The method of claim 1, wherein the shape is representative of:
a three-dimensional model of the object,
a two-dimensional area covered by the object,
a bounding volume of the object, or
a bounding area of the object.

3. The method of claim 1, wherein the step of obtaining the position of the object relative to the device further comprises:
receiving a first set of coordinates representative of a position of the device,
receiving a second set of coordinates representative of a position of the object, and
determining the position of the object relative to the device based on the first and second sets of coordinates.

4. The method of claim 1, wherein the step of obtaining the position of the object relative to the device further comprises:
emitting a sense signal by an emitter of the device,
receiving a reflection of the sense signal reflected off the object, and
determining the position of the object relative to the device based on the reflection of the sense signal.

5. The method of claim 1, wherein the step of obtaining the position of the object relative to the device further comprises:
capturing an image of the object,
analyzing the image, and
determining the position of the object relative to the device based on the analyzed image.

6. The method of claim 1, wherein the embedded code is further representative of the predetermined position of the light source relative to the object.

7. The method of claim 1, wherein the device comprises an image capture device and an image rendering device, and wherein the method further comprises:
capturing, by the image capture device, an image of the object,
determining a position of the object in the image,
determining a position of the shape relative to the object in the image,
determining a virtual position for a virtual object relative to the shape in the image, and
rendering the virtual object as an overlay on the physical environment at the virtual position on the image rendering device.

8. The method of claim 1, wherein the device is a vehicle.

9. The method of claim 8, wherein the object is a road user or road infrastructure.

10. The method of claim 1, wherein the shape's size, form and/or position relative to the object is based on:
a movement speed of the object,
a user input indicative of a selection of the size and/or the form,
a user profile,
a current state of the object, and/or
weather, road and/or visibility conditions.

11. The method of claim 1, further comprising the steps of:
capturing an image of the object,
identifying one or more features of the object in the image,
determining the two-dimensional or three-dimensional shape of the object based on the one or more features,
detecting light emitted by a proximate light source, which proximate light source is in proximity of the object, which light comprises an embedded code comprising a light source identifier of the proximate light source,
identifying the proximate light source based on the embedded code, and
storing an association between the proximate light source and the two-dimensional or three-dimensional shape of the object in a memory.

12. A computer program product for a computing device, the computer program product comprising computer program code to perform the method of claim 1 when the computer program product is run on a processing unit of the computing device.

13. A device for receiving spatial information of an object, the device comprising:
a light detector configured to detect light emitted by a light source associated with the object, which light comprises an embedded code representative of a two-dimensional or three-dimensional shape having a predefined position relative to the object, and
a processor configured to obtain a position of the object relative to the device, and to determine a position of the shape relative to the device based on the predefined position of the shape relative to the object and on the position of the object relative to the device,
wherein the light source has a predetermined position relative to the object, processor is configured to obtain the position of the object relative to the device by:
determining a position of the light source relative to the device, and
determining the position of the object relative to the device based on the predetermined position of the light source relative to the object.
